(19) United States
(12) Patent Application Publication
(10) Pub. No.: US 2026/0286777 A1
(43) Pub. Date: Sep. 24, 2026

(54) IMPROVEMENTS IN OR RELATING TO FURNITURE

(71) Applicant: Charlotte WEBB, Buntingford, Hertfordshire (GB)

(72) Inventor: Charlotte WEBB, Buntingford, Hertfordshire (GB)

(21) Appl. No.: 19/472,379

(22) PCT Filed: Apr. 8, 2024
(86) PCT No.: PCT/GB2024/050931

§ 371 Date: Oct. 3, 2025

(30) Foreign Application Priority Data
Apr. 6, 2023 (GB) 2305234.3

(51) Int. Cl. E06C 1/00; A47C 4/02; E06C 1/10; E06C 7/50

(52) U.S. Cl. CPC E06C 1/005; A47C 4/025; A47C 4/027; E06C 1/10; E06C 7/50

(57) ABSTRACT

A module configurable between a chair configuration and a ladder configuration. The module includes first and second interlocking portions, each interlocking portion including first and second longitudinal support members and at least one transverse member therebetween, configured such that the longitudinal support members of the second portion are nestable between the longitudinal support members of the first portion. Orientation of the first and second interlocking portions is configurable between cross-wise interlocking in the chair configuration and linear interlocking in the ladder configuration.

### CROSS REFERENCE TO RELATED APPLICATIONS

This application is the U.S. National Phase Application of PCT International Application No. PCT/GB2024/050931, filed Apr. 8, 2024, which claims priority to Great Britain Patent Application No. 2305234.3, filed Apr. 6, 2023, the contents of such applications being incorporated by reference herein.

### FIELD OF THE INVENTION

The present invention relates to a module which is configurable between a chair configuration and a ladder configuration, and an associated method of use. The present invention also relates to a ladder system comprising one or more chair/ladder modules and an associated method for constructing a ladder.

### BACKGROUND OF THE INVENTION

Ownership of motorhomes is very popular, whether it be for living in or for holidays. As with all mobile homes, space is at a premium. Owners of those motorhomes still require regular access to such things as moveable seating and, potentially less regularly but still importantly, a ladder to get onto a roof for storage and/or maintenance purposes. In addition, there is a growing community of people living in small eco homes, who suffer from the same disadvantage and potentially have similar requirements for storage and maintenance.

There are, of course, a multitude of offerings having one defined purpose available to purchase, but saving space is an important consideration. If one can transport/store one piece of equipment having more than one defined purpose, it saves the space required for the second piece of equipment.

Although a ladder may be used les regularly, it must be sturdy and capable of safely conveying a user to a roof height/onto a roof of a vehicle and, to save space, it should have a dual purpose and/or be useful at other times too.

Whilst the Applicant is aware of some furniture which, in one configuration, acts as a chair and, in a second configuration, acts as two or three steps, this cannot convey a person onto a roof of a motorhome. Nor can it be easily stored or flat-packed to save space when being transported on not in use.

With that in mind, it is perceived there is a need for dual purpose space-saving furniture, and the invention is aimed at just that.

### SUMMARY OF THE INVENTION

According to a first aspect, the present invention provides a module, configurable between a chair configuration and a ladder configuration, the module comprises first and second interlocking portions, each interlocking portion comprising first and second longitudinal support members and at least one transverse member therebetween, configured such that the longitudinal support members of the second portion are nestable between the longitudinal support members of the first portion, wherein orientation of the first and second interlocking portions is configurable between cross-wise interlocking in the chair configuration and linear interlocking in the ladder configuration.

Preferably, a pair of transverse members of the first interlocking portion are longitudinally and laterally spaced so as to form an aperture into which the second interlocking portion is locatable in chair and ladder configurations.

Preferably, the aperture comprises a longitudinal space for receipt of the second interlocking portion in a ladder configuration and a lateral space for receipt of the second interlocking portion in a ladder (and/or storage) configuration.

Preferably, the module is a chair/ladder module.

Preferably, the first and second interlocking portions are configurable into a storage configuration, being a different linear interlocking configuration to the ladder configuration.

Preferably, the first and/or second interlocking portion(s) comprise(s) first and second longitudinal support members and at least one transverse member therebetween.

Preferably, the at least one transverse member is weight-bearing.

Preferably, the first and/or second interlocking portion(s) comprise(s) support means, for engagement with the other interlocking portion.

Preferably, the first and/or second interlocking portion(s) comprise(s) a pair of opposed abutment surfaces, having a space therebetween, for engagement with the other interlocking portion.

Preferably, the pair of opposed abutment surfaces are located on opposed surfaces of the one or each longitudinal support member.

Preferably, a first support means on the first interlocking portion is configured to bear the weight of the second interlocking portion (and preferably, in use, that of a user) in the chair configuration.

Preferably, the first interlocking portion comprises a second support means spatially arranged from the first support means, such that the second interlocking portion may be slid therebetween and so supported between opposing surfaces of the first and second support means in the chair configuration.

Preferably, opposing surfaces provide an interference fit between the first and second portions in the chair configuration.

Preferably, the first and second support means are located on opposite planar sides of the first interlocking portion.

Preferably, each support means comprises a transverse support member operatively connected to each of the first and second longitudinal support members.

Preferably, each support means is configured to contact a longitudinal support member of the other portion, in the chair configuration.

Preferably, the first and second interlocking portions comprise one or more weight-bearing transverse slats, for bearing weight in the chair and/or ladder configurations.

Preferably, the transverse slats are equidistantly arranged.

Preferably, the first and second interlocking portions are operatively connectable to provide linear interlocking and cross-wise interlocking portions, and are separatable into distinct and separate first and second interlocking portions.

Preferably, at least one the first and second longitudinal support members of the first interlocking portion comprises one or more pairs of opposed abutment surfaces, having a space therebetween, for engagement with the other interlocking portion.

Preferably, both the first and second longitudinal support members of the first interlocking portion comprise one or more pairs of opposed abutment surfaces.

Preferably, first abutment surfaces of the first interlocking portion interact with the second interlocking portion, in a cross-wise condition thereof, preventing rotation by interacting with opposed surfaces of the first and/or second longitudinal support member(s) of that second interlocking portion.

Preferably, second abutment surfaces of the first interlocking portion interact with the second interlocking portion, in a linear condition thereof, preventing rotation movement by interacting with opposed surfaces of the first and/or second longitudinal support member(s) of that second interlocking portion

Preferably, first and second abutment surfaces are located on a pair of transverse slats.

Most preferably, the pair of transverse slats are arranged on opposed surfaces of the first and second longitudinal support members of the first interlocking portion, providing both elongate and lateral spaces for receipt of the second interlocking portion in different configurations.

Preferably, the first interlocking portion is a backrest portion comprising one or more ladder slats spatially arranged along the backrest portion.

Preferably, the spatially arranged slats of the backrest portion are configured to provide rungs of a ladder.

Preferably, the ladder rungs are equidistantly arranged along the length of the backrest portion and, further preferably, spatially arranged along the majority of the length of the first interlocking portion.

Preferably, the second interlocking portion is a seat portion comprising one or more seat slats arranged in (relatively) close proximity.

Preferably, the seat slats are arranged from the middle to one end of the second interlocking portion. Most preferably, a first seat slat comprises overhangs, which limit insertion of the seat portion into the backrest portion.

Preferably, the first and second interlocking portions are correspondingly sized so as to allow the portions to be stacked in an overlapping configuration.

Preferably, the first and second interlocking portions are nestable, slidable and/or rotatable with respect to each other, so as to vary the amount of longitudinal overlap and/or the angular configuration thereof.

Preferably, the longitudinal support members of the second portion are nestable between the longitudinal support members of the first portion, in each configuration.

Preferably, transverse members of the second portion extend to the width of the first portion.

According to a second aspect, the invention provides a ladder system comprising a plurality of modules according to the first aspect, wherein the plurality of modules are configured to be longitudinally stackable, and securable, so as to provide a ladder of varying length of modules.

Preferably, a further chair/ladder module is laterally oriented as a base module and operatively secured to a lower module of the plurality of chair/ladder modules having an upright configuration.

Preferably, one or more transverse members of the laterally oriented module interlock with one or more transverse members of the lower of the upright ladder modules.

Preferably, one or more slats of the laterally oriented module interlock with one or more slats of the lower of the upright ladder modules.

According to a third aspect, the present invention provides a method for constructing a ladder comprising a plurality of modules according to the first aspect, wherein: a first end of a first module is operatively connected to a first end of a second module.

Preferably, a third module is operatively connected to a free end of the second module, and so on for subsequent modules.

Preferably, the method comprises:
first and second interlocking portions of a first module are longitudinally oriented and caused to overlap such that respective ends of the longitudinal support members are spatially arranged and are, thereby, staggered;
a second module is introduced to an end of the first module and, owing to its staggered ends, respective ends of a first and second portion of the second module are, thereby, staggered, which increases the strength of a connection of the first and second modules, wherein one or more first portions of the first and second modules and/or one or more second portions of the first and second modules are secured together.

Preferably, a seat portion is arranged to provide a bottom of the ladder and support for a first rung of the ladder provided by the backrest portion, and a backrest portion is arranged to provide one or more additional ladder rungs in-line with the first rung.

Preferably, starting from a storage configuration, the seat portion and the backrest portion are separated, the backrest portion or seat portion is rotated 180 degrees about its longitudinal axis, and the two portions are brought into contact so an upper seat slat of the seat portion contacts and supports a first ladder slat of the backrest portion, thereby, creating a/the first rung of the ladder.

Preferably, further modules in their storage configuration are easily added to the staggered top of a preceding module, staggering its seat portion and backrest portion and creating one or more further rungs of the ladder.

Preferably, one or more respective ends of longitudinal support members of the first module are secured to respective ends of longitudinal support members of the second module. Further preferably all four ends are secured.

Preferably, first and second modules, and subsequent modules, form a contiguous set of ladder rungs for safe climbing.

According to a fourth aspect, the invention provides use of a module to provide chair, ladder and/or storage configurations, the module being according to the first aspect, wherein:
in the chair configuration, the first and second interlocking portions have a cross-wise interlocking configuration and are slidably and rotatably moveable to a linear interlocking configuration so as to form the ladder configuration or storage configuration;
in the ladder configuration or storage configuration, the first and second interlocking portions have a linear interlocking configuration and are slidably and rotatably moveable to a cross-wise configuration so as to form the chair configuration; and/or
in the storage configuration, the first and second interlocking portions have a linear interlocking configuration and are slidably moveable and/or rotatably moveable into a different linear interlocking configuration to form the ladder configuration or are slidably and rotatably moveable to a cross-wise configuration so as to form the chair configuration.

Preferably, the invention provides use of a plurality of modules in a storage configuration, and stacking the plurality of modules.

Preferably, the invention provides use of a plurality of modules in a ladder configuration, and joining together the plurality of modules to form an elongate ladder.

According to a fifth aspect, the present invention provides use of at least one interlocking portion of a module according to the first aspect to provide a ladder section, the portion being arranged such that one end rests on a surface and at least part of the portion rests against an upright or elevated surface against which the portion is rested in a leaning configuration.

Most preferably, the module is provided in a storage configuration, in which first and second interlocking portions provide a ladder section which can be used as is.

Advantageously, the present invention provides a space-saving chair/ladder module, which can be transformed between a chair configuration and a ladder configuration. Further advantageously, space is saved by the chair/ladder module being dual-purpose, and there being no need for separate ladders and chairs. Space is still further saved by the chair/ladder module having a storage configuration, allowing it to be efficiently stacked vertically or horizontally during transportation/non-use.

Advantageously, the invention will be beneficial to the campervan/motorhome community as it is functional and, yet, space-saving. It is also beneficial to those having smaller homes or smaller properties where outside space is quite limited, but where a fully functional ladder is still of benefit for, e.g. maintaining the roof and/or guttering.

Advantageously, many people do not have space for solid 3-metre ladders which might only be used very occasionally; however, people will almost always have space for foldable garden furniture which is used more regularly. If such furniture has a dual purpose, it is of added advantage.

Tradesmen having limited space for storage or smaller vehicles will benefit from space-saving ladders, especially if the requisite safety standards are met, as contemplated through use of the present invention.

Advantageously, one of the interlocking portions may alone be used as a ladder section, without additional support from the other interlocking portion. Most preferably, the backrest portion may be used as a ladder section by itself.

Further advantageously, a single module may be used as a ladder section.

Advantageously, overhangs of a first seat slat improve stability and strength, and prevent the chair portion from being slid too far through the backrest portion.

As used herein, the term ‘nestable’ is used to describe a relationship between longitudinal members of the first portion and longitudinal members of the second portion in which the longitudinal members of the second portion are locatable within a volume or space created between the longitudinal members of the first portion. The skilled person will understand that, in each configuration, the longitudinal members of the second portion are nestable or nested between the longitudinal members of the first portion. In other words, the longitudinal members of the second portion are always, when in use, within the bounds of the longitudinal members of the first portion. As used herein, ‘interlocking’ is intended to describe how the first and second interlocking portions engage with each other or fit together by partial overlapping or interpenetration of parts. Those skilled in the art will understand how such interlocking can take different forms in different configurations, and yet the portions still be interlocked. For instance, in the chair configuration, the first and second interlocking portions are, generally, provided in a cross-wise condition (creating at least a seat part and a backrest part), whereas, in the storage and/or ladder configuration(s), the first and second interlocking portions are, generally, provided in a linear condition (albeit a different linear relationship for each of the ladder and storage configurations).

### BRIEF DESCRIPTION OF THE DRAWING FIGURES

The invention will now be disclosed, by way of example only, with reference to the following drawings, in which:

FIG. 1 is a front elevation of first and second interlocking portions of a chair/ladder module shown, for convenience, side-by-side;

FIG. 2 is a front elevation of the chair/ladder module of FIG. 1 in a storage configuration, in which the first interlocking portion is shown frontward-facing and the second interlocking portion is shown rearward-facing;

FIG. 3 is a front elevation of the chair/ladder module of FIG. 1 in the storage configuration, in which the second interlocking portion is shown frontward-facing and the first interlocking portion is shown rearward-facing;

FIG. 4 is a perspective view of the chair/ladder module in a chair configuration;

FIGS. 5 to 8 are elevations of first and second chair/ladder modules of FIG. 1, shown during step-wise construction of a ladder configuration;

FIG. 9 is an exploded view of the abutment and connection of first and second chair/ladder modules; and

FIG. 10 is a perspective view of a base module, being an additional chair/ladder module, and a lower chair/ladder module in the ladder configuration.

### DETAILED DESCRIPTION OF THE INVENTION

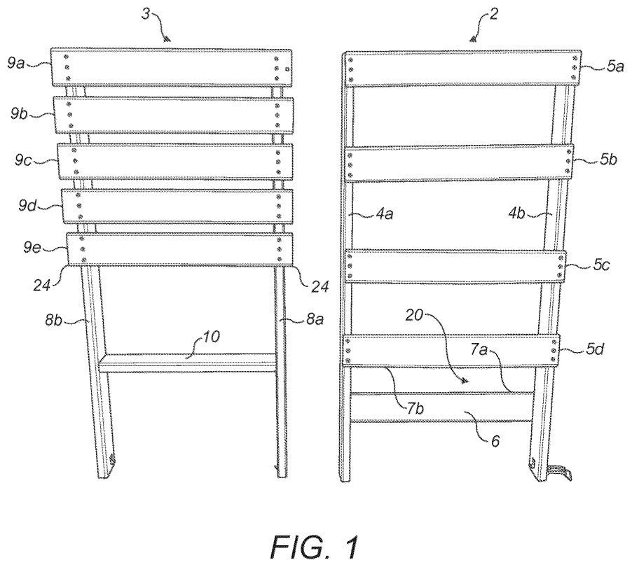

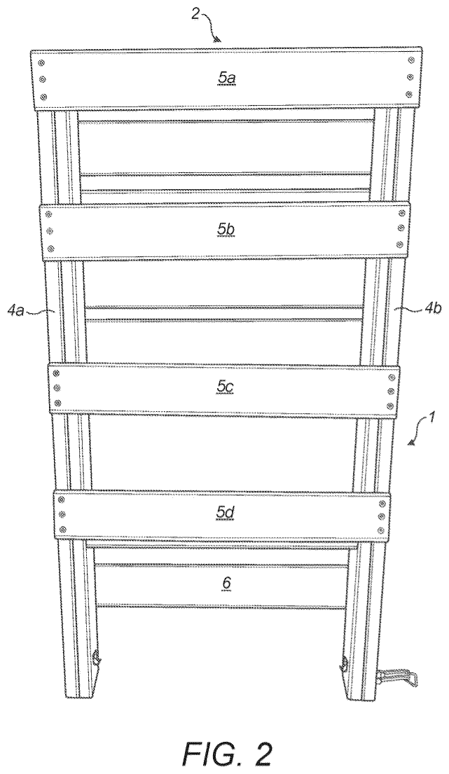

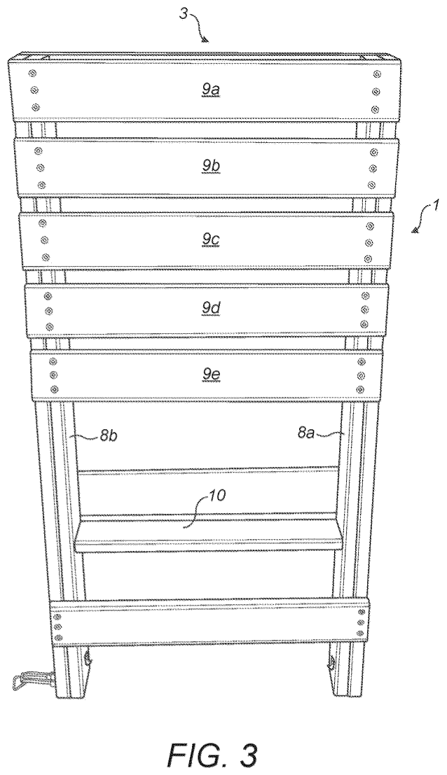

FIGS. 1 to 4 show an individual chair/ladder module, being identified generally by reference 1. Each module 1 has first and second interlocking portions 2; 3, in which the first portion 2 provides a backrest portion 2 and the second portion 3 provides a seat portion 3. For convenience, from hereon these will be referred to as ‘backrest portion 2’ and ‘seat portion 3’. The backrest portion 2 and the seat portion 3 are moveable with respect to each other, and configurable between at least a chair configuration and a ladder configuration, although it should be noted that portions 2; 3 are also configurable into a storage configuration, as shown in FIGS. 2 and 3.

The backrest portion 2 includes a pair of longitudinal support members 4a; 4b which, together with a plurality of spatially arranged transverse members 5, provide a framework to the backrest portion 2. The transverse members 5 are shown attached to a front-facing surface of the longitudinal support members 4a; 4b, in FIG. 2, and end flush with edges of the longitudinal supports members 4a; 4b. In the figures four similarly sized transverse members 5a; 5b; 5c; 5d may be seen bridging the longitudinal support members 4a; 4b; however, that number is not essential and the four members could be replaced by any number of members, including one oversized member. The transverse members 5 of the backrest portion 2 have dual utility and provide a backrest for a user to rest against in the chair configuration and provide ladder rungs in the ladder configuration. As such, they need to be strong and weight-bearing.

A support member 6, which member is for engagement with the seat portion 3, is shown attached on the opposed surfaces (rearward-facing in FIG. 2) of the longitudinal support members 4a; 4b, which is important for securing portions 2; 3 together in the ladder configuration. Whilst support member 6 is shown as a single member bridging the longitudinal support members 4a; 4b, it should be noted that a pair of individual (un-connected) support members (having individual and unconnected abutment surfaces) could be placed, one on each of the longitudinal support members 4a; 4b, and achieve the same function.

Opposed upper and lower surfaces 7a; 7b (abutment surfaces 7a; 7b) of the support member 6 and the lower-most transverse member 5d, respectively, together with parts of the longitudinal support members 4a; 4b define an aperture 20 for receipt of the seat portion 3 for construction of the chair configuration. In which configuration, the surfaces 7a; 7b are provided so as to contact the seat portion 3 and secure both portions 2; 3 against undesired movement. It should be noted that aperture 20 provides both a longitudinal space between respective ends of the longitudinal support members 4a; 4b, and a lateral space between opposed edges/surfaces of those longitudinal support members 4a; 4b. Support member 6 and the lower-most transverse member 5d are longitudinally spaced along the longitudinal support members 4a; 4b and are provided on opposed edges/surfaces of the members 4a; 4b, thereby creating two forms of separation. The longitudinal space is utilised in the chair configuration, and the lateral space is utilised in the ladder and storage configurations to maintain contact between portions 2 and 3, as described more below.

The seat portion 3 includes a pair of longitudinal support members 8a; 8b which, together with a plurality of transverse members 9 arranged in close proximity, provide a framework to the seat portion 3. The transverse members 9 are provided on a front-facing surface of the longitudinal support members 8a; 8b, when seen in FIG. 3. Five transverse members 9a; 9b; 9c; 9d; 9e are shown bridging the longitudinal support members 8a; 8b; however, that number is not essential and the five members could be replaced by any number of members, including one oversized member. Each of the transverse members 9 connects together the longitudinal support members 8a; 8b, and extends a small distance beyond the edges of the support members 8a; 8b. Rear-facing surfaces are kept clear of any fixings, etc., allowing the seat portion 3 to be easily slid into aperture 20 (longitudinal space), and prevent any such fixings, etc. fouling the backrest portion 2 in the storage configuration. The transverse members 9 of the seat portion 3 have dual utility and provide a seat for a user to sit on in the chair configuration and provide strength and support in the ladder configuration, as the seat portion 3 is intended to provide a strong footing and bottom to a ladder in the ladder configuration.

The seat portion 3 also includes a support strut 10 providing additional strength and support to longitudinal support members 8a; 8b.

FIGS. 2 and 3 show a storage configuration of the backrest portion 2 and seat portion 3, in which respective edges and ends of the two portions are substantially flush with each other. As such, the seat portion 2 sits within the overall dimensions of the backrest portion 2. FIG. 2 shows the backrest portion 2 in a frontward-facing condition and the seat portion 3 in rearward-facing condition, whereas FIG. 3 shows the seat portion 3 in a frontward-facing condition and the backrest portion 2 in a rearward-facing condition. The storage configuration provides the most space-saving condition for each module 1, and a plurality of modules may be stacked substantially horizontally, one on top of the other, or substantially vertically, side-by-side, or end-on-end. It will be noted from at least FIGS. 2 and 3 that the seat portion 3 nests within the backrest portion 3, and longitudinal support members 8a; 8b of the seat portion both abut and sit within the longitudinal support members 4a; 4b of the backrest portion. The portions 2; 3 are both slidable and rotatable whilst still interlocking, and/or may be separated from one interlocking condition and brought back into a second interlocking condition.

For the most efficient stacking, a backrest portion of one module is located abutting a backrest portion of a second module, with the two modules being slightly off-centre so transverse members of one portion may sit between transverse members of the other backrest portion (not shown).

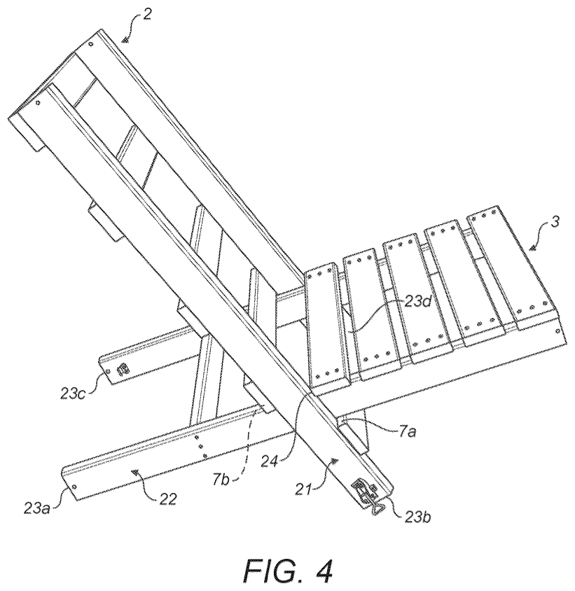

FIG. 4 shows a chair configuration of chair/ladder module 1, in which the transverse members 5—of the backrest portion 2—provide backrest slats 5, and the transverse members 9—of the seat portion 3—provide seat slats.

Seat portion 3 rests within aperture 20 (longitudinal space) formed in the backrest portion 2 to create a form of X-shaped chair configuration. Lower ends 21; 22 of the backrest portion 2 and seat portion 3 provide four feet 23a; 23b; 23c; 23d, upon which the chair configuration rests and is supported. Cushions (not shown) may be used to aid comfort. By way of an alternative, one or more feet 23a; 23b; 23c; 23d may be angled or curved to provide greater floor contact, or may be partially rotatable, again to provide greater floor contact.

The chair configuration may be constructed from the storage configuration of FIGS. 2 and 3 in the following manner. Starting from that storage configuration, the backrest portion 2 and seat portion 3 are separated, and individually rotated to provide the orientations shown in FIG. 4, in which backrest slats 5—of portion 2—face a rear of the chair and inside surfaces thereof form the backrest per se, and seat slats 9 are upwards-facing. Seat portion 2 is slid into aperture 20 (longitudinal space) until overhangs 24 of a first seat slat 9e abut longitudinal support members 4a; 4b (of the backrest portion), which limits its travel any further. As feet 23a; 23b; 23c; 23d are brought into contact with a surface upon which they will rest, this rotates and biases portions 2; 3 into a reclining position having, effectively, an X-shape, and brings abutment surfaces 7a; 7b into contact with the longitudinal support members 8a; 8b of the seat portion, thereby, providing a form of interference-fit connection between the two portions 2; 3. It should be noted that addition of a user's weight to the chair reinforces the interference-fit connection rather than weakening it, owing to the X-shape configuration.

To collapse the chair configuration, the steps above are, essentially, reversed, and the seat portion 3 is simply slid out from aperture 20 (longitudinal space), and portions 2; 3 may be nested again to resume the storage configuration.

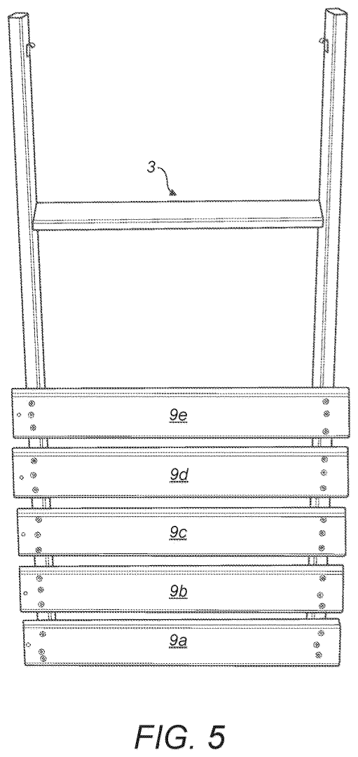

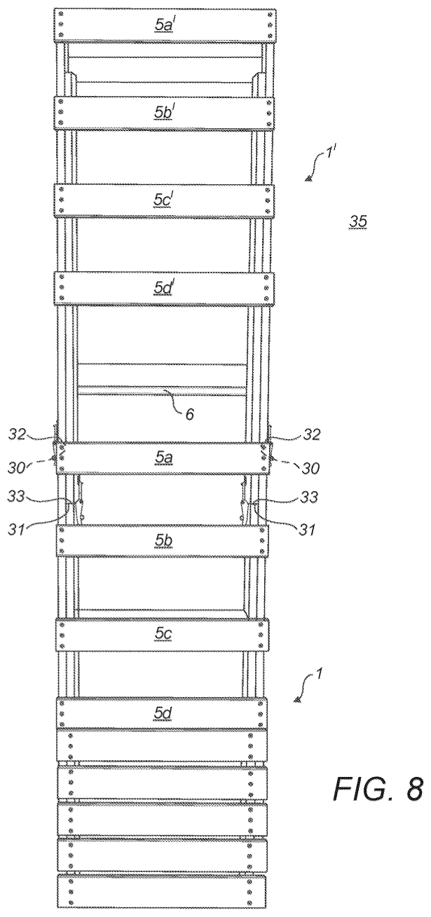

FIGS. 5 to 9 are provided to aid description of construction of the ladder configuration. The ladder configuration shown in FIG. 8 includes two chair/ladder modules 1; 1′. Both modules 1; 1′ are identical and according to the module described in relation to FIGS. 1 to 3 above. As identical, the exact arrangement and nomenclature of components of the second module 1′ will not be repeated; however, those components of the second module 1′ will be differentiated by the inclusion of the prime symbol: ′.

The ladder configuration may be constructed from the storage configuration of FIGS. 2 and 3 in the following manner. Starting from that storage configuration, the backrest portion 2 and seat portion 3 of module 1 are first separated—in essence, the seat portion 3 is slid from the backrest portion 2, removing the seat portion 3 from the aperture 20 (lateral space). The seat portion 3 is oriented to show the condition in FIG. 5, in which its transverse members 9 are facing away from a surface against which the ladder will be leant, and with its longitudinal support members 8a; 8b in an upright condition—forming ladder stiles. The transverse members 9 are provided at the bottom of a proposed ladder. Strong and sturdy feet, or a single foot, are provided by the transverse member 9e and/or the ends of longitudinal support members 8a; 8b which, optionally, may be angled, curved or partially rotatable to improve contact with the ground.

It may be noted that seat portion 3 is inverted from the seat portion 3 shown in FIG. 1, but the backrest portion 2 has the same orientation to that shown in FIG. 1 (and FIG. 2). The backrest portion 2 is brought into engagement with the seat portion 3 by being lowered onto (or simply brought into contact with) the seat portion 3, whereby the longitudinal support members 4a; 4b—of the backrest portion 2—are caused to slide along an outside of the longitudinal support members 8a; 8b—of the seat portion 3. Longitudinal support members 8a; 8b slide between the transverse members 5 and the support member 6, through the lateral space of aperture 20, which members 5; 6 then abut surfaces of the members 8a; 8b, preventing movement—which is specifically beneficial as this maintains the orientation of the stiles/both portions 2; 3 in a linear condition—or straight line—as one would expect from a normal ladder. Owing to the abutting relationship between transverse member 5 on one side of the longitudinal support members 8a; 8b and support member 6 on the opposed side, this substantially prevents lateral movement and/or twisting of the portions 2; 3 under load or during movement and/or placement of the ladder configuration.

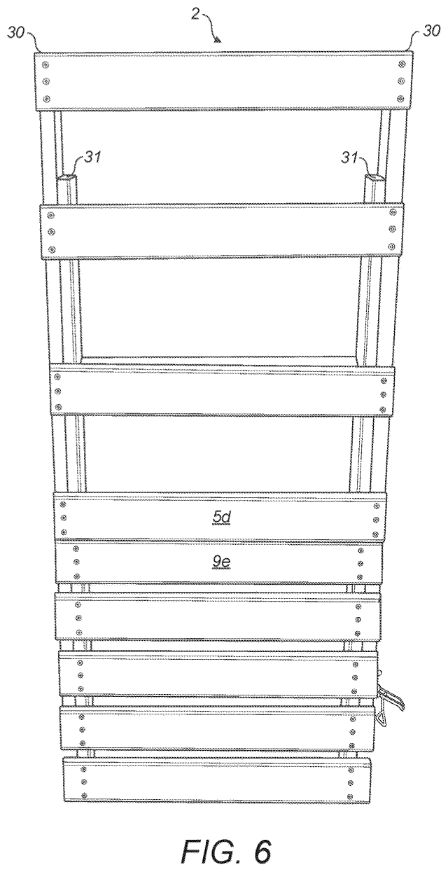

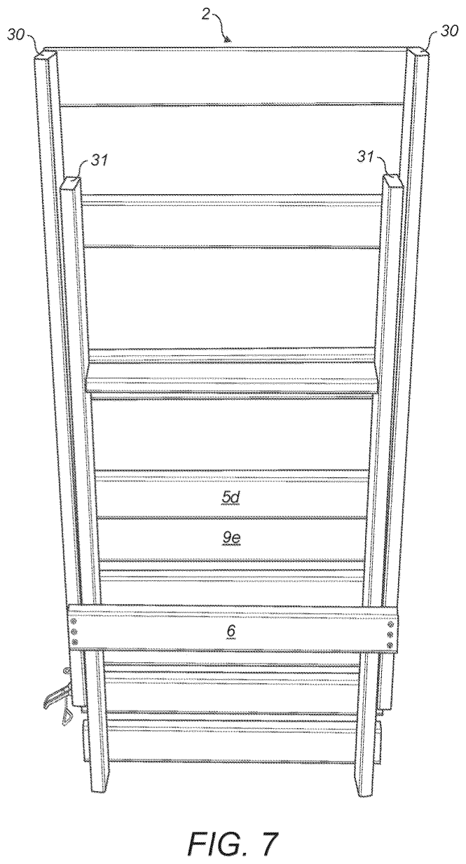

At the end of engagement, lowest transverse member 5d of portion 2 rests on top of the upper most transverse member 9e of portion 3, the member 5d providing a first ladder rung. This condition is shown in FIG. 6. FIG. 7 shows the same arrangement as FIG. 6; however, from the rear, where longitudinal support members 8a; 8b can be seen to be received between transverse member 5d and support member 6, within aperture 20 (lateral space).

It should be noted that the construction shown in FIGS. 6 and 7 already provides a short ladder configuration; however, further modules may be added to increase the overall length of the ladder constructed. Further, the construction shown in FIGS. 6 and 7 provides a staggered condition, whereby upper ends 30 of the longitudinal support members 4a; 4b are staggered from upper ends 31 of longitudinal support members 8a; 8b. If further modules are added, this staggered arrangement significantly improves the efficacy and strength of a connection between respective ends of two modules.

A further chair/ladder module 1′ may be added to an upper region (upper ends 30; 31) of the first module 1. The further module 1′ need not be altered from its storage configuration shown in FIG. 2, and lower ends 32; 33 of its members 4a′; 4b′; 8a′; 8b′ are brought into contact with upper ends 30 of members 4a; 4b, whereby members 8a′; 8b′ of module 1′ slide within the channel thereby created between members 4a; 4b of module 1, until lowers ends 33 of members 8a′; 8b′ abut upper ends 31 of members 8a; 8b, which provides a staggered effect. In that configuration of staggered overlap, additional strength is provided to the longitudinal support members through the use of one or more latches 34, connecting together the upper and lower ends 30 and 32, and 31 and 33 of the members of the modules 1; 1′.

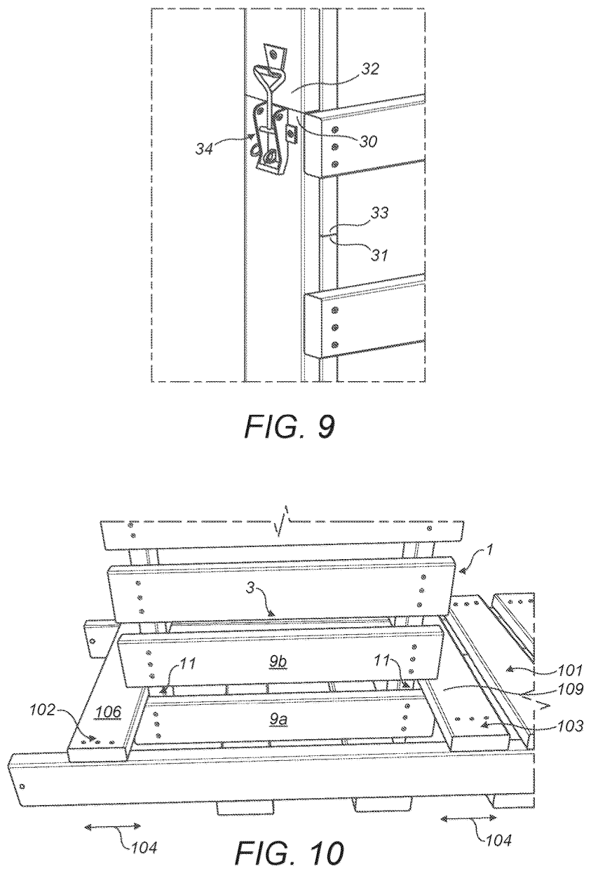

Although in FIG. 9 only one latch 34 is visible, ends of all abutting members are preferably latched together for additional strength/support. This condition is shown in FIG. 8, in which two modules 1; 1′ are connected as described above. A first rung of the ladder is provided by the lower most transverse member 5d of the backrest portion 2, and a further three rungs are provided by the other members 5c; 5b; 5a (in order). The addition of a second module 1′ on top of the first module 1 provides an additional five rungs of a ladder, with the lowest rung being provided by support member 6′ and the transverse members 5d′; 5c′; 5b′; 5a′ (in order) providing the next four rungs of the ladder. The ladder is shown placed against an upright surface 35 where a user can easily climb the ladder so as to gain height.

It will be understood by those skilled in the art that an upper region of module 1′ is again provided with a staggered effect, such that a further module may be added, and subsequent modules also, using the same steps as described above for the addition of module 1′.

The ladder configuration may be disassembled, essentially, by reversing the steps above through undoing latches 34, and removal of module 1′ before the portions 2; 3 of module 1 are disconnected, and re-assembled into the storage configuration.

For ladders of up to two modules, these can be erected either in situ against a target upright surface or wall, or can be constructed on the ground and then erected into position. For ladders of more than two modules, it is expected that these will be constructed on the ground and then erected.

Although the ladder may be used as shown in FIG. 8, local health and safety laws may require a ladder over a certain height to have a widened base/increased footprint. For example, in the United Kingdom, EN 131 Standard requires ladders of over three metres to have a widened base.

As shown in FIG. 10, a further module 101, being identical to modules 1; 1′ may be horizontally oriented and placed upon the ground with the backrest 102 lying on the ground, and seat portion 103 on top. Backrest and seat portions 102; 103 are slidable with respect to each other, as exemplified by arrow 104, and slid apart somewhat to receive the seat portion 3 of the bottom of the ladder configuration of FIG. 6 or 8, or, indeed, a ladder configuration of any desired number of modules. FIG. 10 shows just the main region of connection between modules 1 and 101.

Conveniently, a transverse member 109 and a support member 106 of the module 101 are caused to engage a slot 11 provided between an upper region of transverse member 9a and a lower region of the next transverse member 9b of module 1, one on each side thereof, when portions 102 and 103 are slid back together. Whereby the ladder configuration is both supported by a widened base, but may be also angled to provide a preferred 70 degree orientation for safe climbing. A plurality of modules may now be constructed over a height of three metres and comply with UK law, by providing a base of greater width.

In a further embodiment, ends of the longitudinal support members may be curved or otherwise shaped to improve their function when acting as either feet in a chair configuration or when providing a foot for the ladder configuration. Further alternatively, non-slip material or foot/feet may be used.

By way of an alternative, in the chair configuration lower ends of the backrest portion and seat portion may each further include a drop-down leg for increased stability.

By way of an alternative, in the ladder configuration, a rear-facing (potentially wall-or upright-facing) surface may include a fold-out support contactable with the ground or the horizontally oriented module. In a modified configuration, the rear-facing fold-out support may form a separate support for the creation of a step ladder.

Preferably, the modules are constructed from wood, plastics or composite materials, making them both strong and light enough to handle, but also aesthetic. Of course, aluminium could be used as an alternative, as this is already widely used for ladders, or fibreglass or a moulded material.

The latch is an adjustable toggle latch; however, this is not essential and other forms of latch or fixing means may be used to connect the longitudinal support members of respective modules.

In a further embodiment, portions of the backrest portion and/or chair portion may be rubberised (or otherwise treated) for improving grip. In particular, a back of the backrest portion may be rubberised to improve grip with a surface upon which the modules will rest in the ladder configuration and/or ends of either portion may be rubberised to improve ground contact/connection of respective modules. Further, ladder rungs may be rubberised, or provided with additional grip portions.

In a yet further embodiment, the module may include one or more armrests appropriately mounted so as to move into position as the chair configuration is constructed. In particular, the one or more armrests may be mounted to at least part of the backrest portion, the chair portion and/or both portions.

1. A module, configurable between a chair configuration and a ladder configuration, the module comprising:
first and second interlocking portions, each interlocking portion comprising first and second longitudinal support members and at least one transverse member therebetween, wherein the longitudinal support members of the second interlocking portion are nestable between the longitudinal support members of the first interlocking portion, wherein orientation of the first and second interlocking portions is configurable between cross-wise interlocking in the chair configuration and linear interlocking in the ladder configuration.

2. The module as claimed in claim 1, wherein the first and second interlocking portions are slidable and/or rotatable with respect to each other, so as to vary an amount of longitudinal overlap and/or an angular configuration thereof.

3. The module as claimed in claim 1, wherein a pair of transverse members of the first interlocking portion are longitudinally and laterally spaced so as to form an aperture into which the second interlocking portion is locatable in chair and ladder configurations.

4. The module as claimed in claim 3, wherein the aperture comprises a longitudinal space for receipt of the second interlocking portion in the ladder configuration and a lateral space for receipt of the second interlocking portion in the ladder configuration.

5. The module as claimed in claim 1, wherein a first support means on the first interlocking portion is configured to bear the weight of the second interlocking portion in the chair configuration.

6. The module as claimed in claim 5, wherein the first interlocking portion comprises a second support means spatially arranged from the first support means, such that the second interlocking portion can slide therebetween and so supported between opposing surfaces of the first and second support means in the chair configuration.

7. The module as claimed in claim 1, wherein each support means comprises a transverse support member operatively connected to each of the first and second longitudinal support members.

8. The module as claimed in claim 1, wherein first and/or second support means of the first interlocking portion is/are configured to contact one of the longitudinal support members of the second interlocking portion, in the chair configuration.

9. The module as claimed in claim 1, wherein the first and second interlocking portions comprise one or more weight-bearing transverse slats, for bearing weight in the chair and/or ladder configurations.

10. (canceled)

11. The module as claimed in claim 1, wherein, the first and second interlocking portions are operatively connectable to provide linear interlocking and cross-wise interlocking portions, and are separatable into distinct and separate first and second interlocking portions.

12-14. (canceled)

15. The module as claimed in claim 1, wherein the at least one transverse member of the second interlocking portion extends to the a width of the first interlocking portion.

16. A ladder system comprising:
a plurality of chair/ladder modules each comprising first and second interlocking portions, each interlocking portion comprising first and second longitudinal support members and at least one transverse member therebetween, wherein the longitudinal support members of the second interlocking portion are nestable between the longitudinal support members of the first interlocking portion, wherein orientation of the first and second interlocking portions is configurable between cross-wise interlocking in a chair configuration and linear interlocking in a ladder configuration,
wherein the plurality of modules are configured to be longitudinally stackable, and securable, so as to provide a ladder of varying length of modules.

17. The ladder system as claimed in claim 16, further comprising a further chair/ladder module that is laterally oriented as a base module and operatively secured to a lower module of the plurality of chair/ladder modules having an upright configuration.

18. The ladder system as claimed in claim 17, wherein one or more transverse members of the further chair/ladder module interlock with one or more transverse members of the lower module.

19. (canceled)

20. A method for constructing a ladder comprising a plurality of modules each module comprising first and second interlocking portions, each interlocking portion comprising first and second longitudinal support members and at least one transverse member therebetween, wherein the longitudinal support members of the second interlocking portion are nestable between the longitudinal support members of the first interlocking portion, wherein orientation of the first and second interlocking portions is configurable between cross-wise interlocking in a chair configuration and linear interlocking in a ladder configuration,
wherein, according to the method, a first end of a first module of the plurality of modules is operatively connected to a first end of a second module of the plurality of modules.

21. The method as claimed in claim 20, wherein a third module of the plurality of modules is operatively connected to a free end of the second module, and so on for subsequent modules.

22. The method as claimed in claim 20, wherein:
the first and second interlocking portions of the first module are longitudinally oriented and caused to overlap such that respective ends of the longitudinal support members are spatially arranged and are, thereby, staggered;
the second module is introduced to an end of the first module and, owing to the staggered ends, respective ends of a first and second portion of the second module are, thereby, staggered, which increases a strength of a connection of the first and second modules, wherein one or more first portions of the first and second modules and/or one or more second portions of the first and second modules are secured together.

23. The method as claimed in claim 22, wherein a seat portion is arranged to provide a bottom of the ladder and support for a first rung of the ladder provided by a backrest portion, and the backrest portion is arranged to provide one or more additional ladder rungs in-line with the first rung.

24. The method as claimed in claim 20, wherein first and second modules, and any subsequent modules, form a contiguous set of ladder rungs for safe climbing.

25. A method for converting a module between chair, ladder and/or storage configurations, the module comprising first and second interlocking portions, each interlocking portion comprising first and second longitudinal support members and at least one transverse member therebetween, wherein the longitudinal support members of the second interlocking portion are nestable between the longitudinal support members of the first interlocking portion, wherein orientation of the first and second interlocking portions is configurable between cross-wise interlocking in a chair configuration and linear interlocking in a ladder configuration,
wherein, according to the method:
in the chair configuration, the first and second interlocking portions have a cross-wise interlocking configuration and are slidably and rotatably moved to a linear interlocking configuration so as to form the ladder configuration or storage configuration;
in the ladder configuration or storage configuration, the first and second interlocking portions have a linear interlocking configuration and are slidably and rotatably moved to a cross-wise configuration so as to form the chair configuration; and/or
in the storage configuration, the first and second interlocking portions have a linear interlocking configuration and are slidably moved and/or rotatably moved into a different linear interlocking configuration to form the ladder configuration or are slidably and rotatably moved to a cross-wise configuration so as to form the chair configuration.
